(19) United States
(12) Patent Application Publication
(10) Pub. No.: US 2012/0020788 A1
(43) Pub. Date: Jan. 26, 2012

(54) WIND ENERGY SYSTEM

(75) Inventor: Dan Lucy, Bozeman, MT (US)

(73) Assignee: The Green Electric Company, A Massachusetts Corporation, Bozeman, MT (US)

(21) Appl. No.: 13/248,997

(22) Filed: Sep. 29, 2011

Related U.S. Application Data
(63) Continuation-in-part of application No. 12/771,898, filed on Apr. 30, 2010.
(60) Provisional application No. 61/256,174, filed on Oct. 29, 2009.
(60) Provisional application No. 61/256,474, filed on Oct. 30, 2009.

(51) Int. Cl. F03D 7/02; F03D 11/00

(52) U.S. Cl. 416/1; 416/204 R; 416/9

(57) ABSTRACT

Wind energy systems comprise a wind accelerator having a support assembly and an outer structure surrounding the support assembly. The wind accelerator has a front region and a rear region. The rear region is substantially wider than the front region, and the outer structure tapers from the rear region to the front region. One or more turbines are mounted on the support assembly at or near the rear region of the wind accelerator or at or near the widest point of the wind accelerator.

### CROSS-REFERENCE TO RELATED APPLICATIONS

This application is a continuation-in-part of and claims priority to U.S. patent application Ser. No. 12/771,898, filed Apr. 30, 2010, which is hereby incorporated by reference in its entirety and is a nonprovisional of and claims priority to U.S. Patent Application Ser. No. 61/256,174, filed Oct. 29, 2009 and U.S. Patent Application Ser. No. 61/256,474, filed Oct. 30, 2009, each of which is incorporated herein by reference in its entirety.

### FIELD

The present disclosure relates to wind energy systems and methods.

### BACKGROUND

Distributed generation wind energy systems, particularly in the medium wind market in the range of 10-1,000 kilowatts (kW) of power generation, can make a substantial environmental impact and meet a growing demand for renewable energy. However, such systems are not economical because most distributed generation wind turbines operate at lower heights than utility scale models, and at these heights wind speed is below the minimum speed needed to make energy recovery economically feasible.

The type of turbine commonly used in distributed generation is a vertical axis wind turbine (“VAWT”). Current VAWTs can not translate the energy from airflow through a blade system effectively because the blade systems can not effectively spin at low altitude, under 100 feet, when the blades are required to spin high (MOI) Generator torque requiring electric generators which are 50 kW and larger.

One approach for solving this problem is to alter the design of the wind turbine or its components in an attempt to improve efficiency. Known adjustments include changing the shape of the turbine blades, incorporating an airfoil stator and even boosting efficiency by harnessing other forms of renewable energy such as the sun by adding solar cells to the wind energy system. However, such approaches increase production costs as specialized manufacturing may be required to produce different turbine designs. Adding solar cells also increases the costs of providing and installing the wind energy system.

Other wind energy systems add wind accelerator components to the turbine to increase the airspeed velocity of the air contacting the turbine blades. In one example of such a system, the accelerator is a frusto-conical funnel-like device intended to direct a stream of wind through the device onto the impeller of a windmill. This system has the disadvantage that the funnel-like device is bulky, fragile and unsightly. More significantly, it functions with horizontal access wind turbines, not the vertical axis turbines common in distributed generation applications.

Therefore, there exists a need for an economical distributed generation wind energy system that can work with existing models of vertical axis wind turbines. Specifically, there is a need for a wind energy system that does not require extra or specialized turbine components. In summary, there is a need for a distributed generation wind energy system that employs a wind accelerator to improve efficiency and can work with existing models of vertical axis wind turbines.

### SUMMARY

The present disclosure, in its many embodiments, alleviates to a great extent the disadvantages of known distributed generation wind energy systems by providing a wind energy system comprising a wind accelerator having a front region and a rear region, a widest point in or near the rear region, and one or more turbines mounted on the rear region of the wind accelerator. Disclosed embodiments allow for low altitude, a 100 feet height or so wind energy generation through wind/velocity acceleration technology which in turn allows disclosed embodiments to effectively generate electricity at low heights by accelerating air from where the air enters the disclosed structure to where the air comes into contact with the VAWT Darrieus or Savonius blade system depending on the utilized structure. This also decreases the torque needed during the Moment of Inertia (MOI) and optimizes the disclosed systems' ability to turn generators at no to low wind speeds. Embodiments utilize wind and velocity acceleration technology to turn Darrieus and Savonius turbine blade systems which usually turn in an unaffected freestanding open air environment through our proprietary wind/velocity acceleration technology.

The wind accelerator may comprise a support assembly and an outer structure surrounding the support assembly. The rear region of the wind accelerator is substantially wider than the front region. The outer structure tapers from the rear region of the accelerator to the front region of the accelerator. The shape of the wind accelerator may be one of the following: a wedge, a tear drop, a tadpole, a V-shape, a W-shape, or a modified wedge, tear drop or tadpole. The turbines may be any type of wind turbine. Exemplary embodiments use vertical axis wind turbines such as Darrieus or Savonius turbines.

The design of the system is such that when air flows across the wind accelerator the air accelerates as it travels across the outer structure from the front region to the rear region. The wind accelerator directs the air into the one or more turbines such that the air contacting the one or more turbines is moving at a higher velocity than air flowing past the front region of the wind accelerator. This velocity increase is approximately 10-50%.

The system may further comprise means for orienting the system so that it faces into oncoming wind. Embodiments of a system can be controlled by a computer program which regulates the amount of power generated. This is optional. The same program allows tracking of electricity generation via an online program which keeps real time track of the energy our system generates. In exemplary embodiments, the wind accelerator may be mounted on a tower or pole to raise it to the desired height, and in exemplary embodiments, is less than about 300 feet in height. Disclosed systems will vary in size and generate between 10 kW to 5 MW of electricity from the wind.

The outer structure of the wind accelerator may be made of hard materials such as Aluminum, Steel, Wood, or Plastic. Alternatively, the outer structure may be made of a flexible material, such as Sail Cloth, which may comprise materials such as Mylar, Dacron, or Cotton or other sail material membrane. The surface of the outer structure may be suitable for direct imprinting of marketing messages or imprinting any words or designs.

Disclosed systems also utilize a reverse air flow technology which captures the eddying air coming off the back of the structure and feeds the air back through the center of the structure which turns the blade on the interior which in turn reduces the needed torque to create optimal electric generation. This also decrease the torque needed during the Moment of Inertia (MOI). In such embodiments, the support assembly may comprise a gantry framework and define a substantially hollow interior. The outer structure may define one or more rear vents and one or more front vents. Air enters the wind accelerator through the one or more rear vents and/or the one or more turbines, travels through the substantially hollow interior and exits the wind accelerator through the one or more front vents.

Embodiments of the disclosure describe a wind accelerator apparatus for the use of capturing wind via wind velocity acceleration technology. The wind accelerator apparatus comprises a front region and a rear region. The rear region of the wind accelerator apparatus is substantially wider than the front region, and the widest point of the wind accelerator apparatus is in or near the rear region. The wind accelerator apparatus may comprise a support assembly and an outer structure surrounding the support assembly. The outer structure tapers from the rear region of the apparatus to the front region of the apparatus. The shape of the wind accelerator apparatus may be one of the following: a wedge, a tear drop, a tadpole, a V-shape, a W-shape, or a modified wedge, tear drop or tadpole. The design of the wind accelerator apparatus is such that when air flows across the apparatus the air accelerates as it travels across the outer structure from the front region to the rear region. One or more turbines may be mounted on the support assembly in the rear region of the wind accelerator.

Disclosed embodiments could be used to create Wind Power anywhere on the planet so long as the wind speed is within the parameters of a favorable environment for electric generation. Commercial Properties, Industrial Properties, Residential Properties and Utility Companies can use the disclosed systems or buy the power the systems generate.

Disclosed embodiments of a Wind Energy Generation System using VAWT Technology and Wind/Velocity Accelerating Technology generate electricity via the wind energy through disclosed structure that captures/translates airflow directly, specifically through a proprietary structure that accelerates the air at the VAWT Blades. The blades then turn and generate electricity via the captured wind energy. Disclosed systems allow for low to high altitude energy production through varying system heights depending on the municipality which permits the system. Disclosed embodiments also utilize aluminum and sail material as the exterior structure cover which are molded into varying specialized air capture formats which create air flow velocity increases.

Exemplary embodiments of a wind energy system comprise a mounting structure and one or more wind turbines mounted on the mounting structure. The mounting structure has a first edge, a second edge, a top edge and a bottom edge. The mounting structure may be one or more of substantially flat, curved, V-shaped, and W-shaped. The one or more wind turbines may be mounted on one or more of the first edge and the second edge of the mounting structure and may be selected from the group: Darrieus vertical axis wind turbine and Savonius vertical axis wind turbine. The mounting structure orients so the one or more wind turbines face into oncoming wind. The system may also include a rectifier and an inverter to provide electricity from the wind turbine. The system may further comprise an orienting assembly in operable connection with the mounting structure. In exemplary embodiments, the orienting assembly comprises a yaw control mechanism, and a control system may be in communication with the orienting assembly. A met tower may be in communication with the control system.

Exemplary embodiments of a renewable energy system comprise a mounting structure and one or more energy conversion devices mounted on the mounting structure. The mounting structure orients the one or more energy conversion devices to enhance their energy capturing capacity. In exemplary embodiments, the one or more energy conversion devices includes a wind turbine. The system may also include a rectifier and an inverter to provide electricity from the wind turbine. The one or more energy conversion devices may include a solar panel.

In exemplary embodiments, the renewable energy system further comprises an orienting assembly in operable connection with the mounting structure. The orienting assembly may comprise a yaw control mechanism, and a control system may be in communication with the orienting assembly. A met tower may be in communication with the control system. In exemplary embodiments, the mounting structure is one or more of substantially flat, curved, V-shaped, and W-shaped.

Exemplary embodiments include methods of orienting a wind energy system, comprising mounting one or more wind turbines on a substantially flat mounting structure having a first edge, a second edge, a top edge and a bottom edge and orienting the substantially flat mounting structure so the one or more wind turbines face into oncoming wind. Exemplary methods may further comprise operably connecting an orienting assembly to the mounting structure, wherein the orienting step comprises using the orienting assembly to orient the mounting structure. The orienting assembly may comprise one or more of a yaw control mechanism, a control system, and a met tower.

Accordingly, it is seen that economical distributed generation wind energy systems are provided in which a wind accelerator improves efficiency through a specialized tapered design and mounts wind turbines thereto to generate energy from wind. These and other features of the present invention will be appreciated from review of the following detailed description of the invention, along with the accompanying figures in which like reference numbers refer to like parts throughout.

### BRIEF DESCRIPTION OF THE DRAWINGS

The foregoing and other objects of the invention will be apparent upon consideration of the following detailed description, taken in conjunction with the accompanying drawings, in which:

FIG. 1 is a perspective view of an embodiment of a wind energy system in accordance with the present invention;

FIG. 2A is a side perspective view of the wind energy system of FIG. 1;

FIG. 2B is a side view of the wind energy system of FIG. 1;

FIG. 2C is a front view of the wind energy system of FIG. 1;

FIG. 2D is a top view of the wind energy system of FIG. 1;

FIG. 3 is a side perspective view of an embodiment of a wind energy system in accordance with the present invention;

FIG. 4 is a perspective view of an embodiment of a wind energy system in accordance with the present invention;

FIG. 5 is a side perspective view of an embodiment of a wind energy system in accordance with the present invention;

FIG. 6 is a perspective view of an embodiment of a wind energy system in accordance with the present invention with the outer structure removed to show an embodiment of a support assembly;

FIG. 7A is a side view of an embodiment of a wind energy system in accordance with the present invention;

FIG. 7B is a top view of an embodiment of a wind energy system in accordance with the present invention;

FIG. 7C is a front view of an embodiment of a wind energy system in accordance with the present invention;

FIG. 8 is a side perspective view of an embodiment of a wind energy system in accordance with the present invention;

FIG. 9 is a perspective view of an embodiment of a wind energy system in accordance with the present invention;

FIG. 10 is a plan view of an embodiment of a wind energy system in accordance with the present invention;

FIG. 11A is a plan view of an embodiment of a wind energy system in accordance with the present invention;

FIG. 11B is a plan view of an embodiment of a wind energy system in accordance with the present invention;

FIG. 11C is a plan view of an embodiment of a wind energy system in accordance with the present invention;

FIG. 12A is a side view of an embodiment of a wind energy system in accordance with the present invention;

FIG. 12B is a top view of an embodiment of a wind energy system in accordance with the present invention;

FIG. 12C is a front view of an embodiment of a wind energy system in accordance with the present invention;

FIG. 13A is a top view of an embodiment of a wind energy system in accordance with the present invention showing air flow;

FIG. 13B is a side view of an embodiment of a wind energy system in accordance with the present invention showing air flow;

FIG. 14 is a schematic showing exemplary electrical connections of an embodiment of a wind energy system in accordance with the present invention;

FIG. 15 is a schematic showing exemplary electrical connections of an embodiment of a wind energy system in accordance with the present invention;

FIG. 16 shows the turbine spin rate as the wind speed increases;

FIG. 17 shows the improved torque using a wedge-shaped embodiment of a disclosed wind accelerator;

FIG. 18 shows the improved power using a wedge-shaped embodiment of a disclosed wind accelerator;

FIG. 19 shows an exemplary embodiment of a renewable energy system in accordance with the present disclosure;

FIG. 20 shows an exemplary embodiment of a wind energy system in accordance with the present disclosure;

FIG. 21 shows an exemplary embodiment of a frame assembly of a renewably energy system in accordance with the present disclosure;

FIG. 22 shows an exemplary embodiment of a wind energy system in accordance with the present disclosure;

FIG. 23 shows an exemplary embodiment of a wind energy system in accordance with the present disclosure;

FIG. 24 shows an exemplary embodiment of a wind energy system in accordance with the present disclosure;

FIG. 25 shows an exemplary embodiment of a slew drive assembly in accordance with the present disclosure;

FIG. 26 shows an exemplary embodiment of a renewable energy system in accordance with the present disclosure;

FIG. 27 shows an exemplary embodiment of a renewable energy system in accordance with the present disclosure; and

FIG. 28 shows an exemplary embodiment of a renewable energy system in accordance with the present disclosure.

### DETAILED DESCRIPTION

In the following paragraphs, embodiments of the present invention will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects. Reference to temperature, pressure, density and other parameters should be considered as representative and illustrative of the capabilities of embodiments of the invention, and embodiments can operate with a wide variety of such parameters. It should be noted that the figures do not show every piece of equipment, nor the pressures, temperatures and flow rates of the various streams.

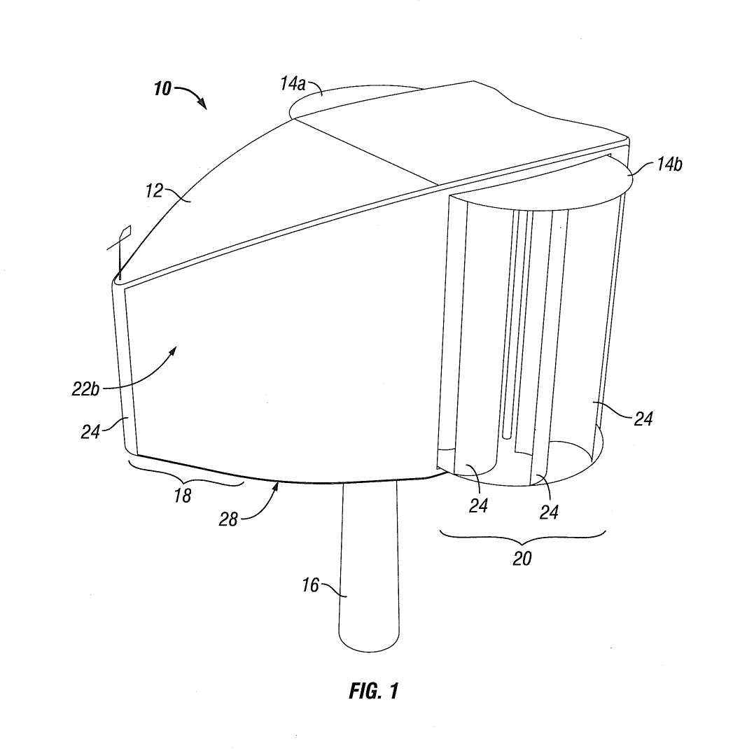

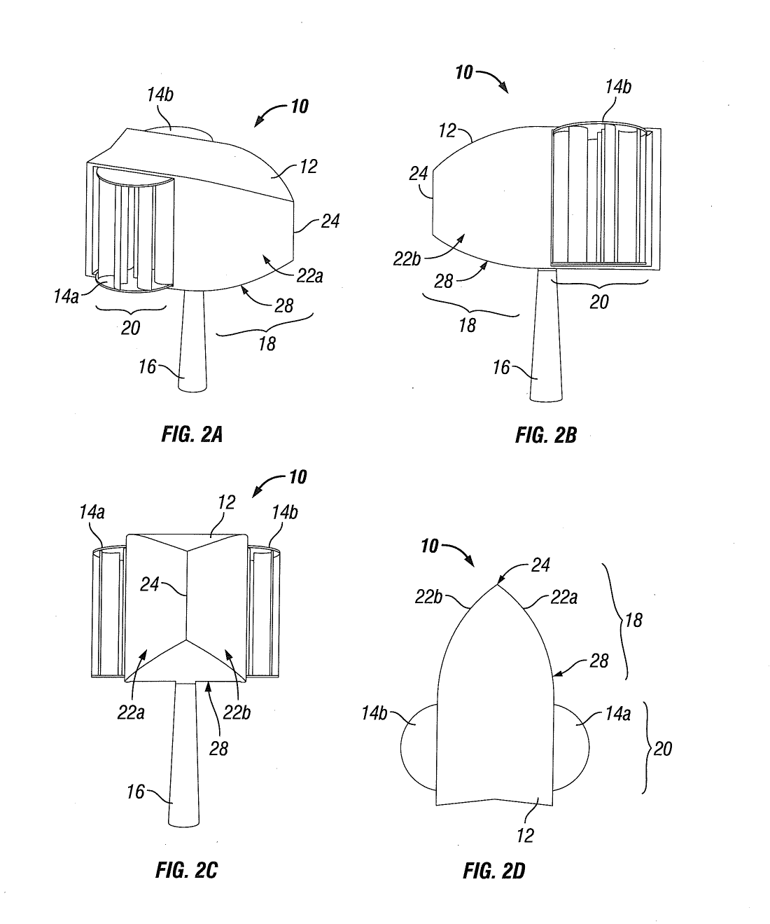

Referring to FIGS. 1-2D, an exemplary embodiment of a wind energy system will be described. Wind energy system 10 comprises wind accelerator 12 and one or more turbines 14a, 14b mounted on the wind accelerator 12. Wind energy system 10 may include a pole 16 of any desired height and may be mounted on the pole 16 so the wind energy system 10 is situated at a desired height to receive oncoming wind. Although disclosed systems can operate at any height, exemplary embodiments are situated at heights up to about 200 feet from ground level to the top of the wind energy system 10. Disclosed embodiments advantageously provide increased efficiency at heights of about 200 feet or less.

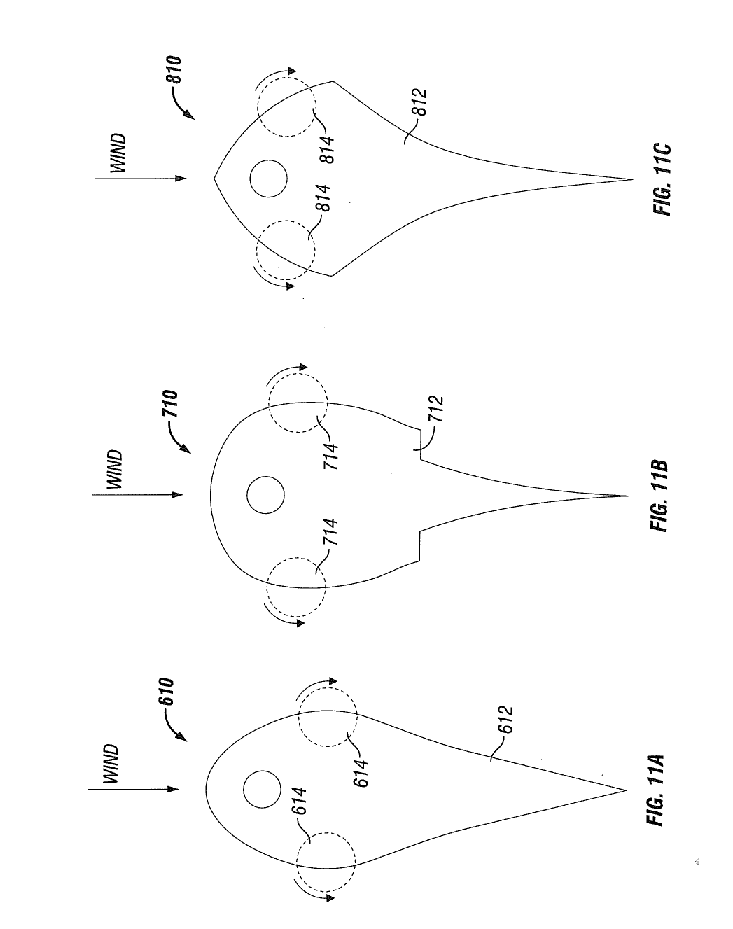

Wind accelerator 12 is in a modified wedge shape depending on the turbine type system utilized, which is installation dependent. The wind accelerator 12 comprises a front region 18 and a rear region 20. In exemplary embodiments, rear region 20 is substantially wider than front region 18. As best seen in FIG. 2D, the sides 22a, 22b of wind accelerator 12 taper from the rear region 20 to the front region 18 and may converge at a front point 24. The angle of the taper from the center line of the wind accelerator may vary between about 15 degrees and about 75 degrees, and in exemplary embodiments, the angle is between about 20 degrees and about 60 degrees. As discussed in more detail herein, wind accelerator 12 is situated so that front region 18 and front point 24 face into oncoming wind, thus optimizing air flow to the turbines 14 through an angle of attack that maximizes air acceleration from the front region 18 to the rear region 20. In many disclosed embodiments, the varying shapes of the wind accelerators described have in common a rear region, a front region and a taper from the rear region to the front region to advantageously accelerate air flow into the blades 29 of the wind turbines 14 mounted on the accelerators. It should be noted, however, that in certain embodiments, for example, those shown in FIGS. 11A-11C, incoming air hits the rear region and some acceleration is achieved by air flowing past a curved rear region.

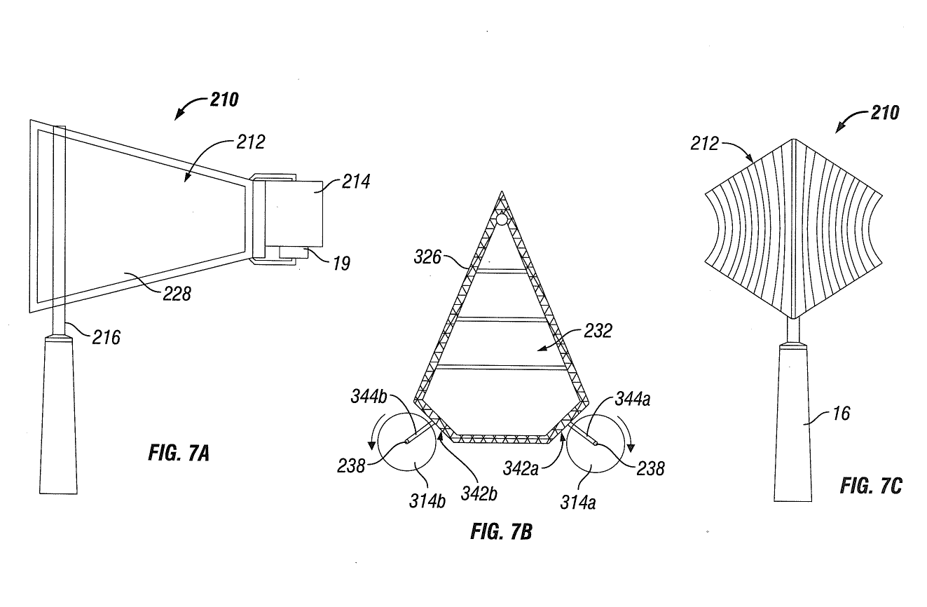

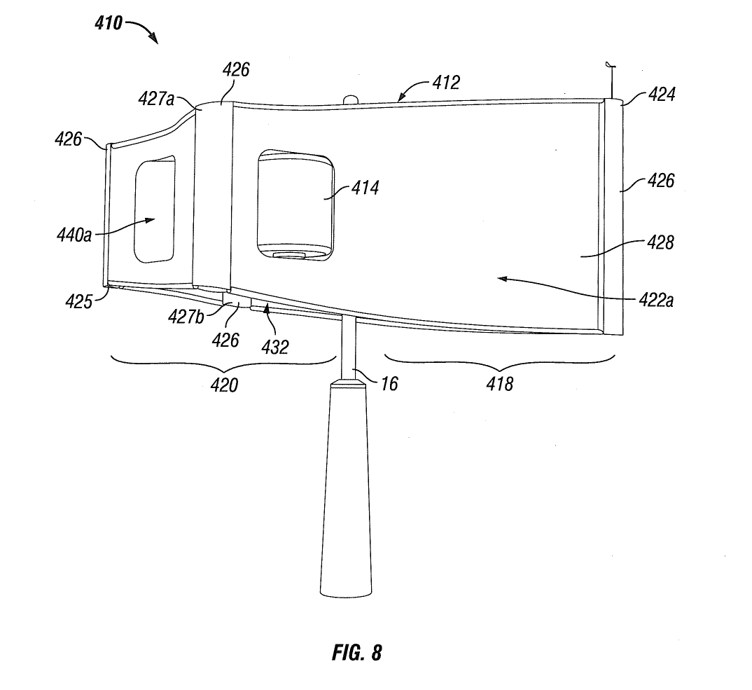

Wind energy system 10, 210 is essentially a tower system which holds the main structure in place, which is set on a specialized foundation, including monopole 16, 216. The main structure of wind accelerator 12, 212 comprises support assembly 26, 226 and outer structure 28, 228 surrounding, or mounted upon, the support assembly 12, 212. As shown in FIGS. 7-8, support assembly 212 utilizes either a system of steel/aluminum tubing members and or a mast and gantry type framework 230 of support members 231 which hold the system components in place. Any arrangement of tubes or wooden frame members may be used so long as sufficient support for outer structure 28, 228 and turbines 14, 214 is provided, and exemplary embodiments are shown, e.g., in FIGS. 7 and 8. Support assembly 226 defines a substantially hollow interior 232 formed by the components of the gantry framework 230 of support members 231.

The Exterior cover, or outer structure 28, of disclosed systems is either based on a Dacron or Mylar, or other types of Sail material or an aluminum or other hard but lightweight material. The material for the cover, or outer structure is chosen based on wind average annual wind speeds at a particular installation. In most installations, either a soft outer structure or hard outer structure could be used. For extremely high wind speeds, a hard outer structure may be required.

One or more wind turbines 14a, 14b are mounted in the rear region 20 of the wind accelerator. Any number of turbines could be utilized with the disclosed wind accelerator, and exemplary embodiments hold 2 to 4 turbines, which connect to a series of either vertical or horizontal mounted generators which range in size between 5 kW to 5 MW in size. Any type of horizontal axis wind turbine or vertical axis wind turbine could be used in connection with the disclosed wind energy systems, and exemplary embodiments employ vertical axis wind turbines (“VAWT”) such as Darrieus or Savonius VAWT blade systems. Typically, a Darrieus blade system is appropriate for units generating power of about 10 kW or lower, and Savonius VAWT units are utilized for larger systems, especially those generating power of more than about 100 kW.

Turbines 14 may be mounted to the wind accelerator 12 at any points along the wind accelerator 12 and may be integrated with support assembly 26 as desired. In exemplary embodiments, wind turbines 14a, 14b are mounted on support assembly 26 in the rear region 20 of wind accelerator 12 via turbine shafts 38.238. The wind turbines 14a, 14b may be mounted such that a first portion 34 of the turbine 14 is disposed within the substantially hollow interior 32 of the support assembly 26 and a second portion 36 of the turbine 14 is located outside the outer structure 28 of the wind accelerator 12. Thus, about half of the turbine 14 is in the path of oncoming wind. Support assembly 26 may include a turbine generator compartment to house generators. In exemplary embodiments, turbine generator compartment may be completely enclosed and waterproof to protect the generators from damage due to inclement weather.

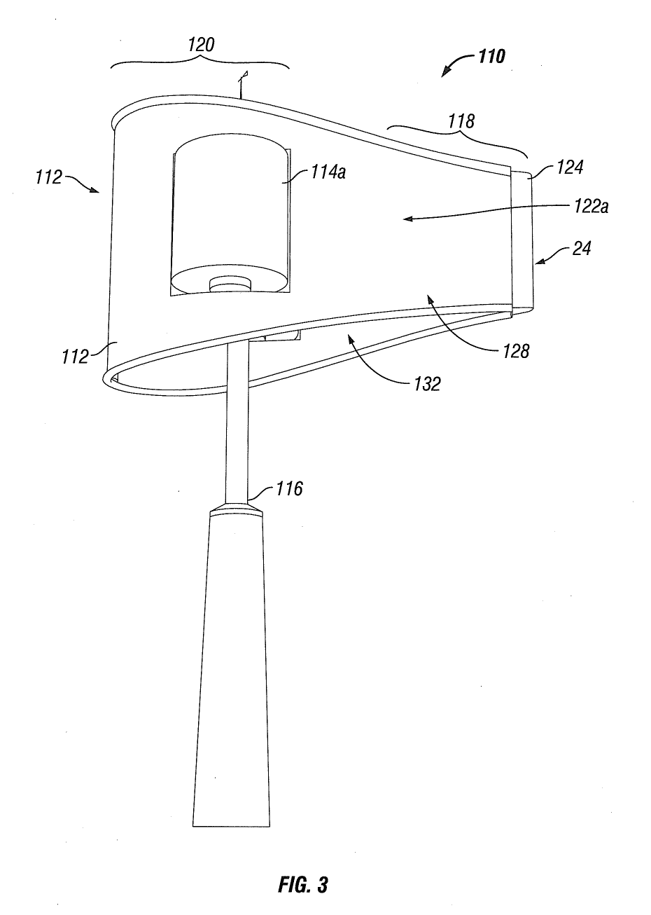

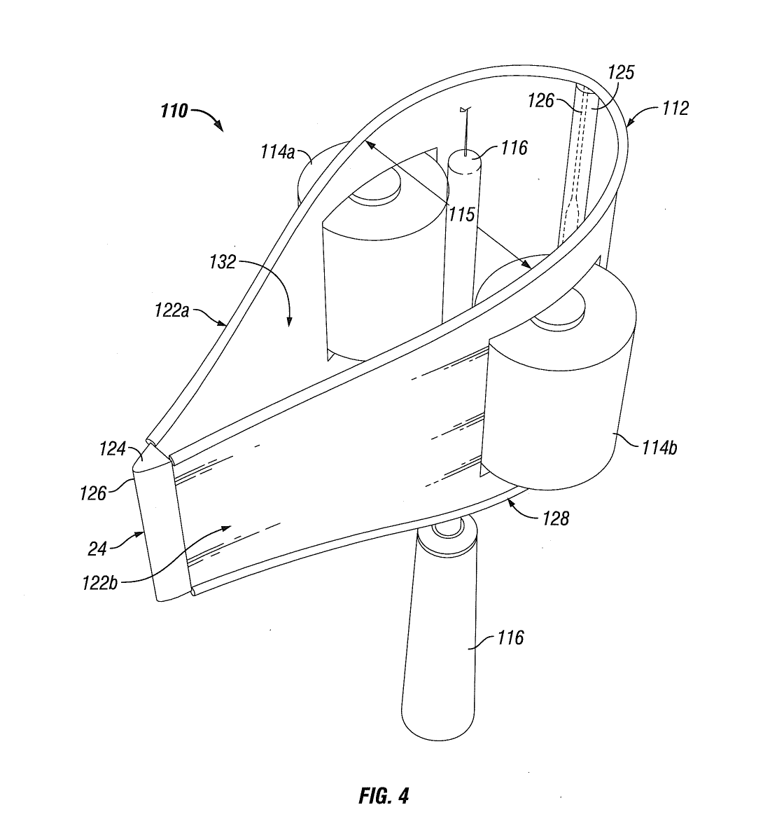

Referring to FIGS. 3-4 exemplary embodiments of a main structure of a wind energy system 110 may be in a “tear drop or “tadpole” shape. Wind energy system 110 comprises the same or similar basic elements as the modified triangle embodiment shown in FIGS. 1-2D. Specifically, wind energy system 110 comprises wind accelerator apparatus 112 having a front region 118 and a rear region 120, with the accelerator's widest point 115 being located in or near the rear region 120 of the wind accelerator apparatus 112. One or more turbines 114 mounted on the wind accelerator apparatus 112 at the rear region 120, and in exemplary embodiments, on each side 122a, 122b at the widest point 115 of the wind accelerator apparatus 112. This is because the widest point of the accelerator typically is the optimal point for wind acceleration and air velocity. Wind accelerator apparatus comprises a support assembly 126 and an outer structure 128 surrounding the support assembly 126.

Exemplary embodiments of a support assembly 126 may include a front point frame member 124 and a rear frame member 125. Outer structure 128 could be a flexible material such as sail cloth or a hard, lightweight material such as aluminum or wood. Rear region 120 is substantially wider than front region 118, and the outer structure 128 of the wind accelerator apparatus 112 tapers from the rear region 120 to the front region 118 and front point frame member 124. Wind turbines 114a, 114b are mounted on the wind accelerator apparatus 112 toward the rear region 120, for example, at the widest point 115, with one turbine 114a, 114b on each respective side 122a, 122b. In exemplary embodiments, the turbines 114a, 114b are mounted at or near the widest point 115 of the wind accelerator apparatus 112. Wind energy system 110 be include a monopole 116 for mounting the system at a desired height to receive wind. Wind energy system 110 may vary considerably in size, and exemplary embodiments are between about 12 feet long by 3 feet tall by 3 feet wide and 800 feet long by 200 feet tall by 200 feet wide.

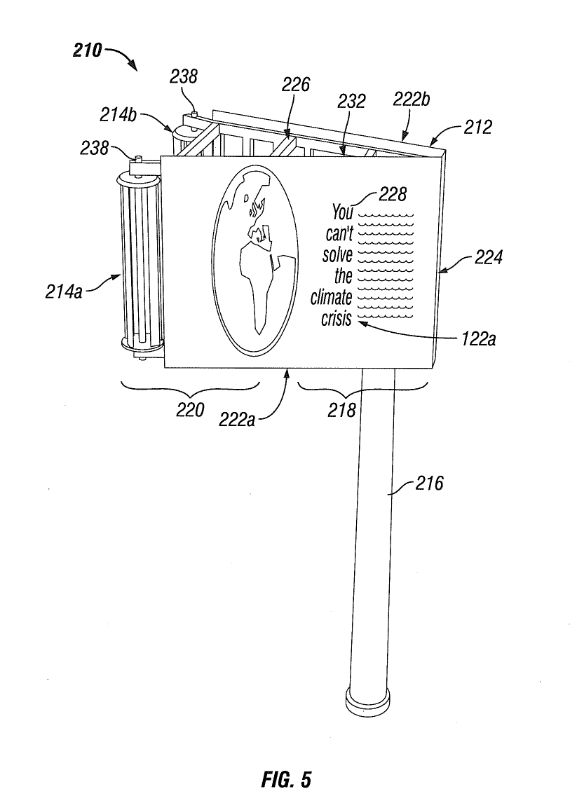

Turning to FIGS. 5-7C, further embodiments of a wind energy system 210 will be described in which wind accelerator 212 is in a “V” shape. Again, the major components remain the same or similar as embodiments employing different shaped accelerators. Wind energy system 210 comprises wind accelerator 212 and wind turbines 214a, 214b mounted on the wind accelerator 212. Wind accelerator 212 comprises a front region 218 and a rear region 220 and tapers from the rear region 220 to the front region 218. In wedge-shaped embodiments, wind accelerator 212 and its support assembly 226 are configured such that the front region 218 includes the front point 224 of the wedge or triangle, and each side 222a, 222b of the wind accelerator forms a substantially straight side of the wedge or triangle. Thus, the rear region 220 of the wind accelerator 212 includes the two other points of the wedge or triangle forms the widest point 215 of the wind accelerator apparatus.

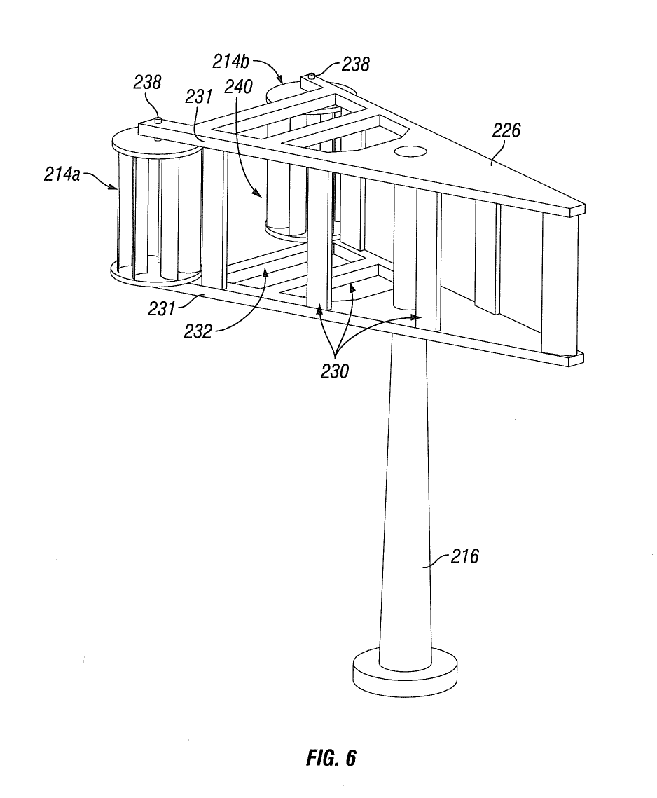

It can be seen that wind turbines 214a, 214b are mounted on the rear regions 220 of wind accelerator 212 at or near the widest point 215 of the wind accelerator. As discussed in more detail herein, this location of the turbines results in high speed air entering the turbine blades for optimal efficiency. As best seen in FIG. 6, support assembly 226 comprises a gantry framework 230 of vertical and horizontal frame members 231, which may be wood or any other material of suitable strength, and forms an air frame for air entering the accelerator's vents, as described below. The support assembly 226 defines a substantially hollow interior 232 within wind accelerator 212. The turbines may be any type of horizontal or vertical axis turbine, and in exemplary embodiments, are of the Savonius or Darrieus type. FIG. 5 shows an embodiment of wind energy system 210 employing a Darrieus type VAWT blade system, and FIG. 6 shows a Savonius VAWT being used. Each turbine 214a, 214b includes a vertical shaft 238 to allow the turbine blades 229 to rotate upon contact with wind, and each turbine is mounted to the support assembly 226 of wind accelerator 212 according to known VAWT mounting procedures. As shown, for example, in FIG. 6 the vertical shaft 238 of each turbine 214a, 214b is coupled to two of support assembly's 226 horizontal frame members 231 such that the turbines are mounted at the rear points of the wedge-shaped wind accelerator 212 and operational to receive airflow coming off the sides 222a, 222b of the wind accelerator 212.

Wind accelerator 212 further comprises an outer structure 228 that surrounds support assembly 226. The outer structure 228 may comprise a soft, flexible material such as sail cloth or substantially hard, but lightweight material such as aluminum, steel, wood, plastic or fiberglass. In exemplary embodiments, the outer structure 228 comprises two planks of a substantially hard material mounted upon each side of the support assembly 226 gantry framework 230, leaving the back of the wind accelerator open. Thus, outer structure 228 defines an open space or interior access area at the back of wind accelerator 212, and this open space may serve as a vent 240. Vent 240 allows air coming off of wind turbines 214a, 214b to flow through into the substantially hollow interior 232 of the wind accelerator 212. The air then exits through the open top and bottom formed by the support assembly 226 of the wind accelerator 212.

FIGS. 7A-7C show wedge-shaped embodiments in which the support assembly 326 of wind accelerator 312 comprises cut-off angled sections 342 to provide mounting locations for the wind turbines 314a, 314b. Each cut-off angled section 342a, 342b comprises a mounting member 344a, 344b for mounting wind turbine 314a, 314b via the turbines vertical shaft 338.

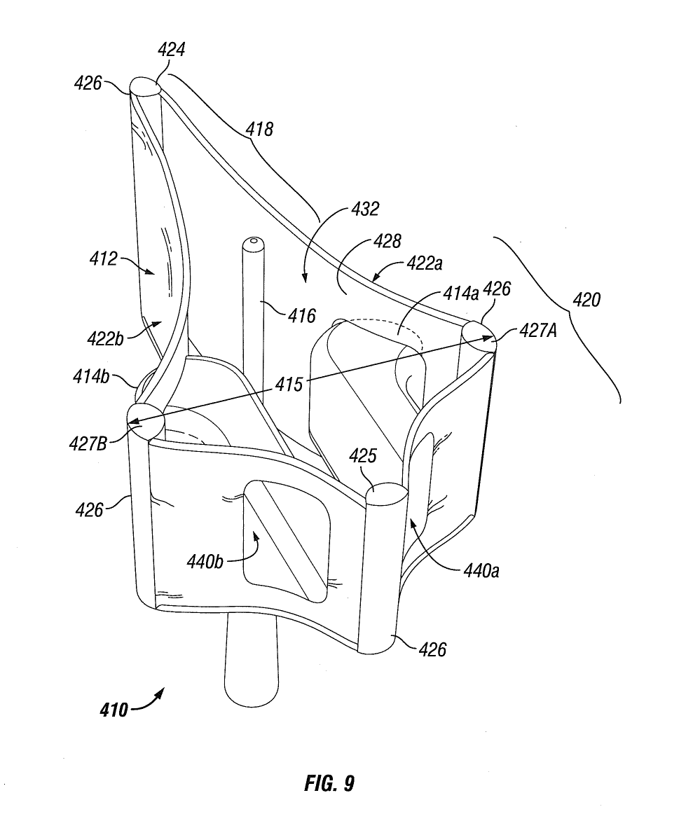

Exemplary embodiments of a wind energy system employing a modified tadpole or modified tear drop shape will now be described with reference to FIGS. 8 and 9. Wind energy apparatus 410 comprises one or more turbines 414 mounted on wind accelerator 412. The wind accelerator 412 has a rear region 420 and a front region 418, and the widest point 415 of wind accelerator 412 is toward the rear region 420. Wind accelerator 412 tapers from the accelerator's widest point 415, located in the rear region 420, to the front point 424 of the accelerator's front region 418. The wind accelerator 412 may be mounted on a tower or pole 416 and include a support assembly 426 and an outer structure 428 surrounding the support assembly 426. In exemplary embodiments, support assembly 426 comprises a front point frame member 424, a rear frame member 425 and two side frame members 427a, 427b.

Outer structure 428 is mounted on support assembly 426 and may be either a soft, flexible material such as Sail Cloth, which may comprise materials such as Mylar, Dacron, or Cotton or other sail material membrane, or a substantially hard material such as Aluminum, Steel, Wood, or Plastic. An outer structure 428 made of sail cloth or other flexible material may be a single loop of material and may be mounted on support assembly 426 by being draped around the support assembly 426 and tightly drawn against front point frame member 424, side frame members 427a, 427b and rear frame member 425. Alternatively, an outer structure made of hard or soft material may comprise several pieces, with a first piece coupled to and extending between front point frame member 424 and side frame member 427a, a second piece coupled to and extending between side frame member 427a and rear frame member 425, a third piece coupled to and extending between rear frame member 425 and side frame member 427b, and a fourth piece coupled to and extending between side frame member 427b and front point frame member 424.

Wind turbines 414a, 414b are mounted on the rear region 420 of wind accelerator 412 such that a first portion of each turbine 14 is disposed within the outer structure 428 of wind accelerator 412 and a second portion of each turbine 14 is located outside the outer structure 428 of wind accelerator 412 to receive oncoming wind. The portions of outer structure 428 that form the sides 422a, 422b of the wind accelerator 412 define turbine mounting apertures 442 sized to fit and allow mounting of turbines 414. As best seen in FIG. 9, the portions of outer structure 428 that form the back of the wind accelerator define vents 440a, 440b, each of which extends to a respective wind turbine 414a, 414b. This vent structure facilitates reverse flow of the air, which eddies off of the back of the wind accelerator 412 and gets carried through the vents 440a, 440b to the portions of the turbines 414a, 414b disposed inside the outer structure 428 of the wind accelerator 412. This extra air flow increases the volume of air that contacts the blades of the turbines and thus boosts the efficiency of the wind energy system 410.

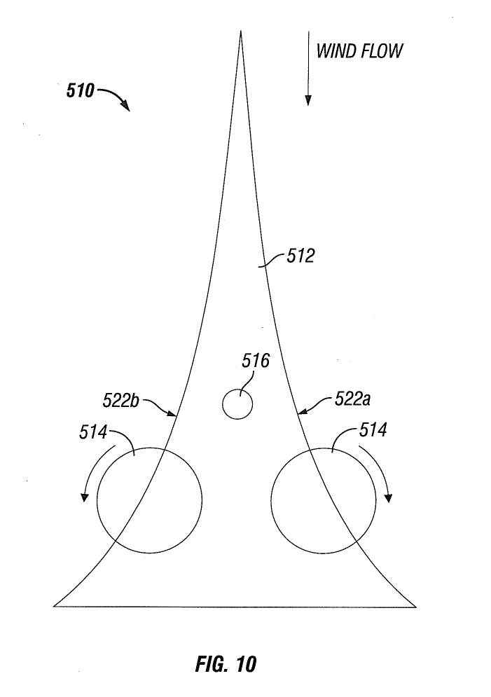

FIGS. 10 and 11A-11C depict additional embodiments of wind energy systems employing different possible shapes of the wind accelerator. It should be noted that all of these embodiments would have the same or similar components as the wind energy apparatus and systems described above. In FIG. 10 it can be seen that wind energy system 510 comprises two turbines 514 mounted on a wind accelerator 512 having a modified wedge shape, with the sides 522a, 522b forming a slightly curved shape rather than the straight lines of a triangle. FIG. 11A shows an embodiment of a wind energy system 610 that includes two turbines 614 mounted on a wind accelerator 612 having tear drop or tadpole shape. As shown in FIG. 11B, an embodiment of a wind energy system 710 includes two turbines 714 mounted on a wind accelerator 712 having a first modified tear drop or modified tadpole shape. FIG. 11C shows an embodiment of a wind energy system 810 wherein the wind accelerator 812 has a second modified tear drop or modified tadpole shape. It should be noted that the embodiments in FIGS. 11A-11C are designed so that the point of the wind accelerator that is the front point in previously described embodiments becomes the rear point and the turbines receive wind from the opposite end of the wind accelerator. Thus, the “front point” of the accelerator may be defined as the point of the accelerator that the air contacts first, and the “front region” may be any portion of the accelerator that the air flows past before it contacts the blades of the wind turbines.

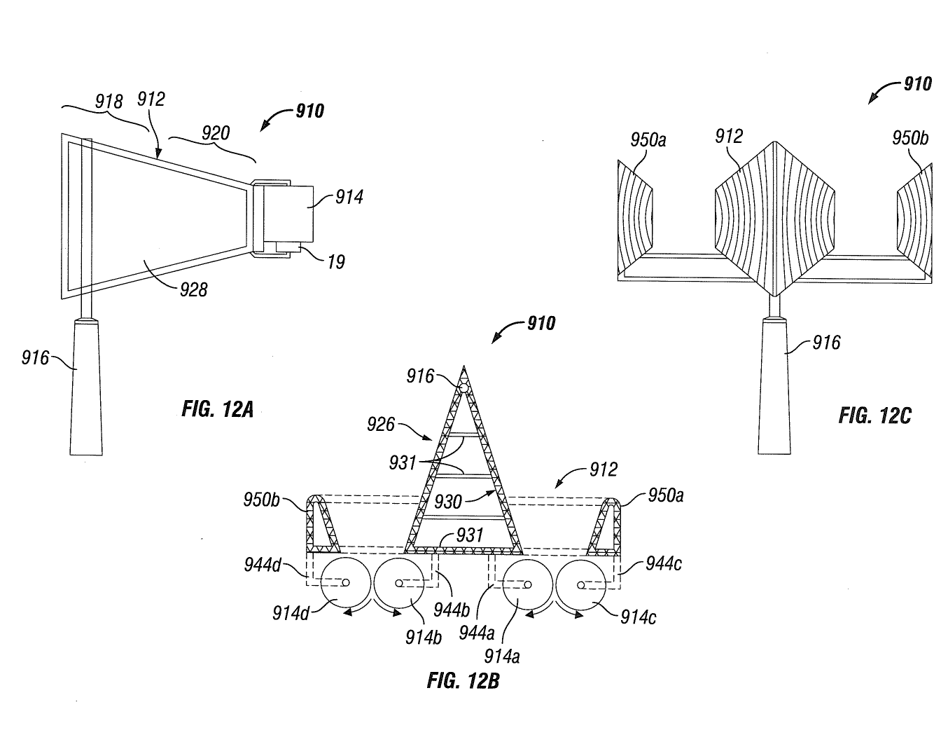

Turning to FIGS. 12A-12C, embodiments of a wind energy system 910 may comprise a plurality of wind turbines 914 and additional peripheral accelerator components 950, such that the system forms a W-shape. Wind energy system 910 comprises a plurality of wind turbines 914a, 914b, 914c and 914d mounted on a main wedge-shaped wind accelerator 912 and two smaller peripheral accelerator components 950a, 950b. Mounting members 944a, 944b are coupled to the back of main wind accelerator 912, and mounting members 944c, 944d are each coupled to a respective peripheral accelerator component 950a, 950b. Wind turbines 914a and 914b are mounted on mounting members 944a and 944b via each turbine's vertical shaft 938. Turbines 914c and 914d are mounted on mounting members 944c and 944d by the vertical shafts 938. The wind accelerator 912 comprises support assembly 926, which may include a gantry framework 930 of frame members 931, and an outer structure 928 surrounding the support assembly. The oncoming wind accelerates from front point 924 of the accelerator's front region 918 to the rear region 920 and contacts the blades of turbines 914a and 914b. Oncoming wind also accelerates as it hits peripheral accelerator components 950a, 950b and travels to contact the blades of wind turbines 914c and 914d.

In operation, wind energy system 10, 110, 210, 310, 410, 510, 610, 710, 810, 910 is pointed into oncoming wind. The wind energy system may include the use of a met tower which orients the systems with the help of a servo mechanism. The use of met towers is known in the art. A met, or meteorological tower, is designed to assess wind resources. Generally a met tower will have anemometers, wind direction vanes, temperature and pressure sensors, and other measurement devices attached to it at various levels above the ground. Disclosed systems also may utilize a Doppler technology that calculates the most optimal orientations for the wind energy system in regards to capturing the air flow.

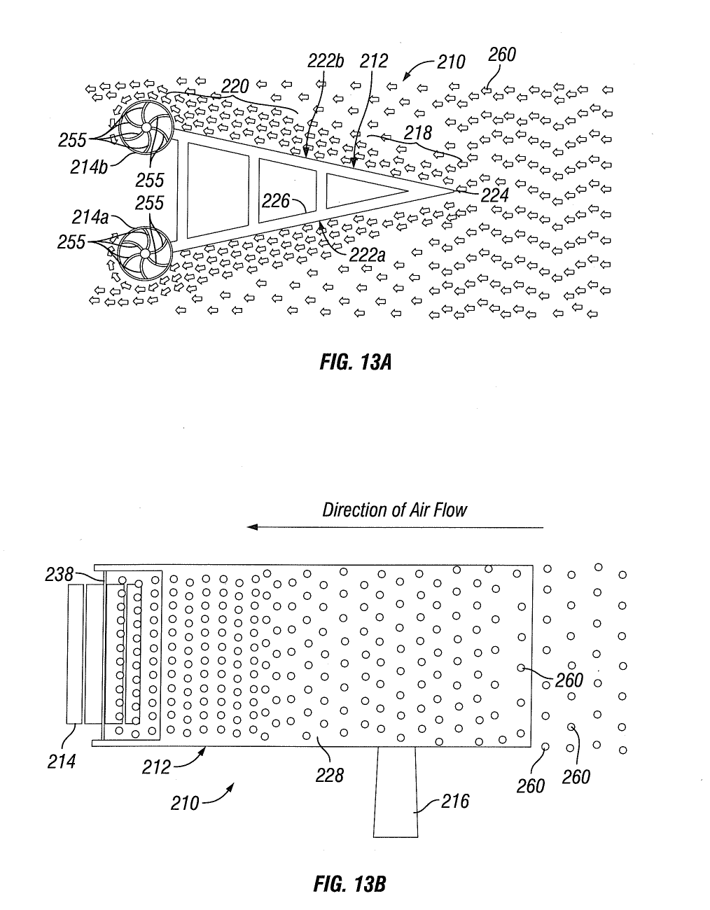

Referring to FIGS. 13A-13B and using wedge-shaped wind energy system 210 as an illustrative example, the system is oriented such that wind or air 260 flows straight into front point 224 of the wind accelerator 212. The air 260 flows across the wind accelerator 212 adjacent both sides 222a, 222b as it travels from the accelerator's front region 218 to its rear region 220. The air or wind speed increases between the point at which the air 260 hits the front point 224 of the accelerator and the point at which the air 260 contacts the blades 255 of the wind turbines 214. This air or wind speed increase or acceleration is depicted in FIGS. 13A-13B by the higher density of arrows and circles representing air 260 as the air 260 moves from the front region 218 to the rear region 220 of the accelerator 212. Thus, the air 260 is directed into the turbines 214 such that the air 260 contacting the turbines is moving at a higher velocity than the air flowing past the front point 224 and front region 218 of the wind accelerator 212. This is because the front points and angled shapes of all disclosed embodiments of wind accelerator eliminated drag and optimizes air flow through the wind turbines. In sum, the wind enters the structure's main field at a lower speed than when it comes into contact with the blade systems the increased air flow turns the blades faster than if the blades were open air free standing blades.

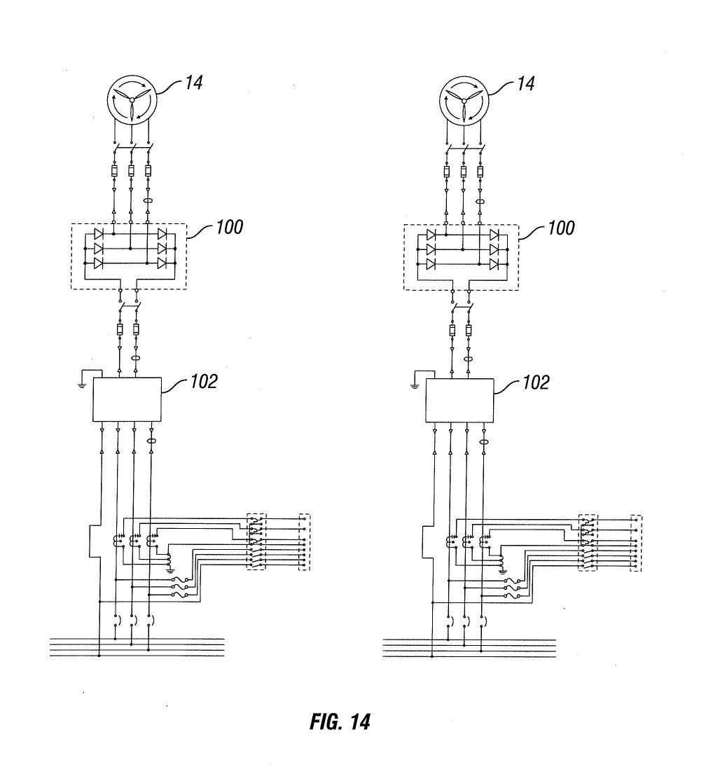

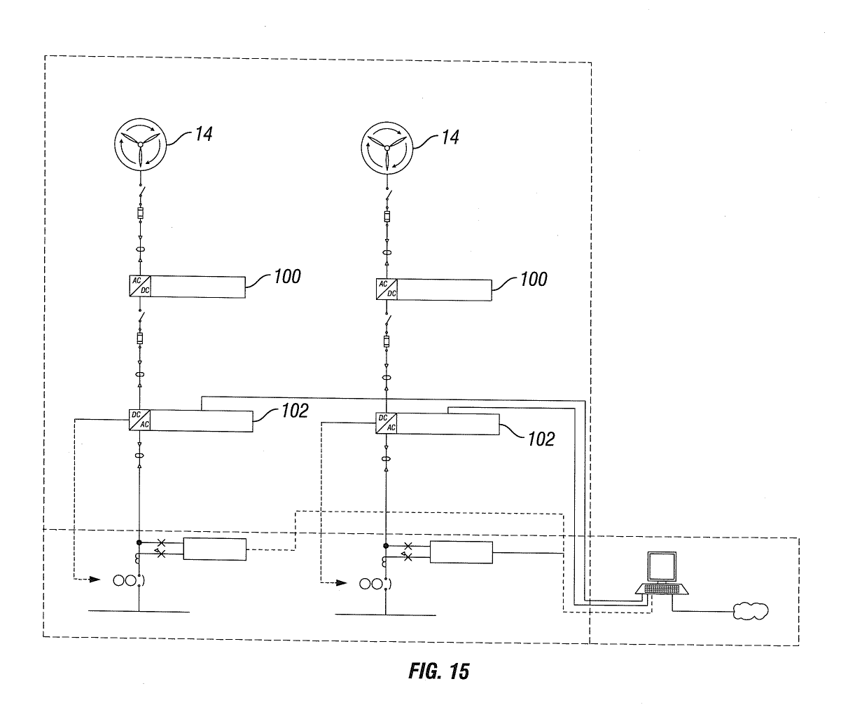

As is known in the art, disclosed wind energy systems connect to an electricity rectifier 100, which cleans up the electric signal by converting the alternating current (AC) output of the turbine to direct current (DC). Rectifiers are known in the art and may be made of solid state diodes, vacuum tube diodes, mercury arc valves, and other components. The system also may utilize a power conditioning inverter 102 which changes DC current to an AC electric current. The use of inverters is well known in the art. FIGS. 14 and 15 are circuit diagrams that show exemplary arrangements of a wind energy system in operable electrical connection with a rectifier and inverter. These components allow disclosed wind energy Systems to offer a clean electric signal to the installation being powered. Utility Transformers, Utility Meters, Utility Circuit Breakers, Site Distribution tools, Wind Power meters, Wind Power Circuit breakers and Main Structure circuit breakers can also be used depending on the system needs.

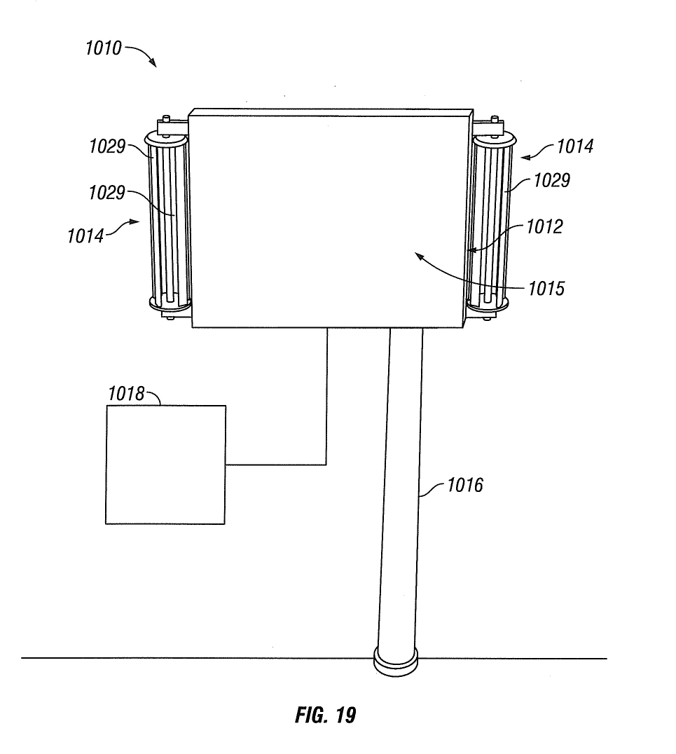

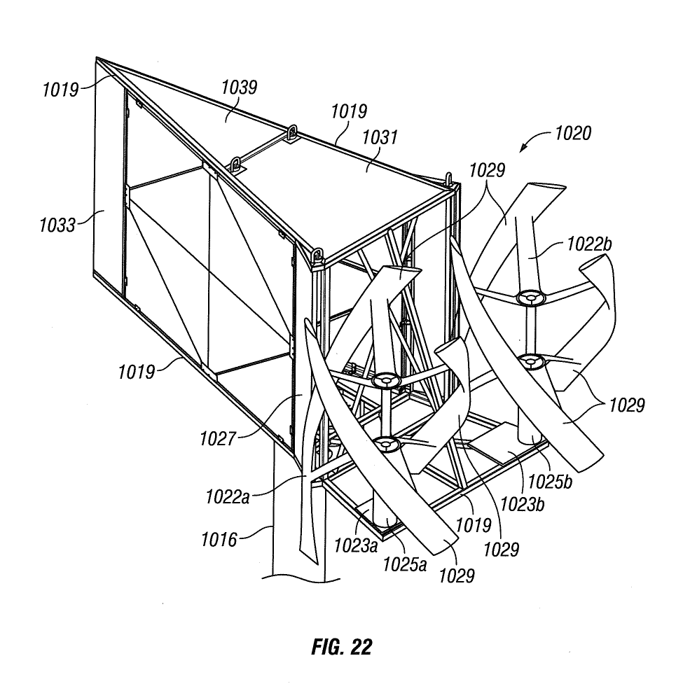

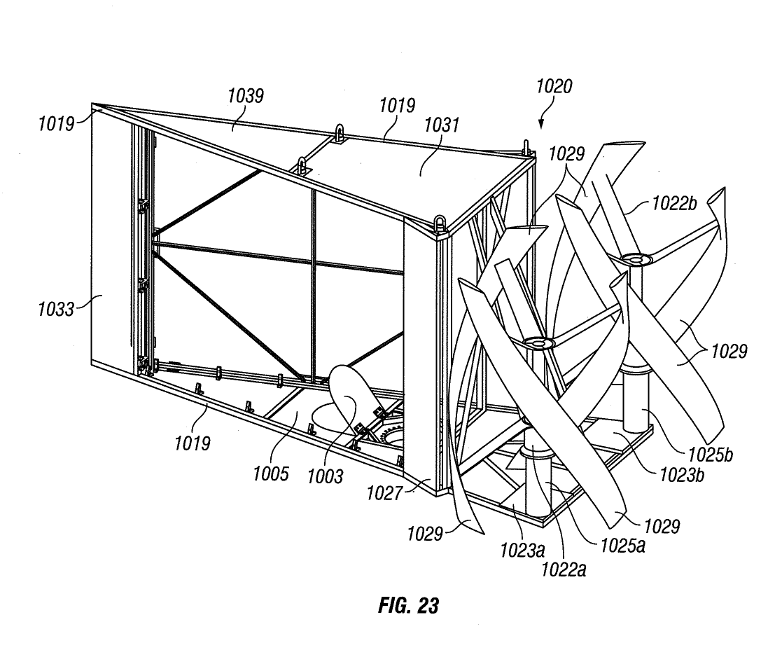

Turning to FIGS. 19-28, exemplary embodiments of a renewable energy system comprise energy conversion devices mounted on a mounting structure, and the mounting structure itself orients to optimize positioning of the energy conversion devices. Renewable energy system 1010 includes a mounting structure 1012 and one or more energy capturing devices 1014 mounted thereto. The mounting structure could be any shape or dimension, and in exemplary embodiments is a substantially flat panel member 1015. The mounting structure 1012 may be mounted on a tower or pole 1016 to elevate the energy conversion devices 1014.

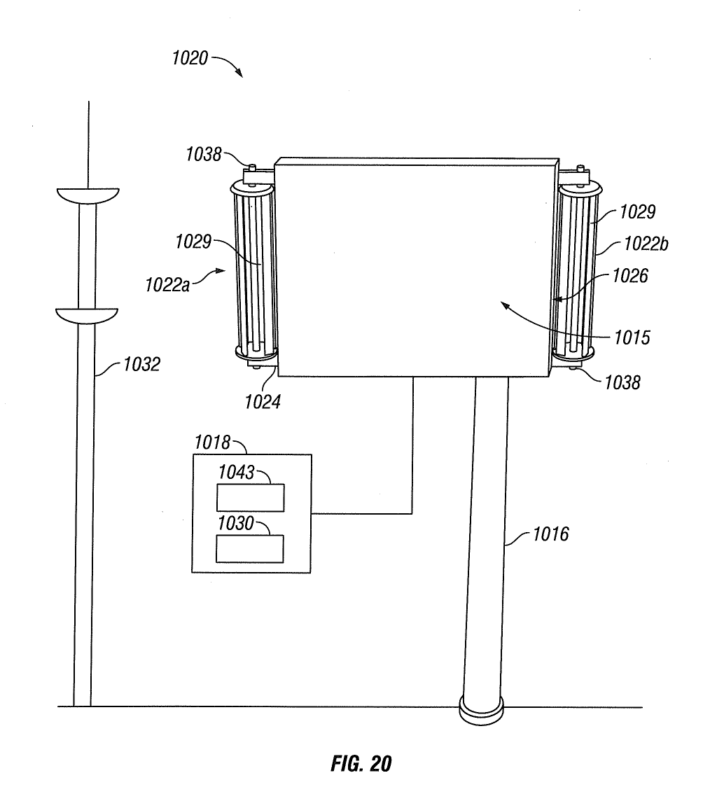

In exemplary embodiments, a renewable energy system may be a wind energy system 1020 wherein the energy conversion devices include one or more wind turbines 1022. The turbines may be any type of horizontal or vertical axis turbine, and in exemplary embodiments, are of the Savonius or Darrieus type. Depending on the size and shape of the mounting structure 1012, any number of wind turbines 1022 could be used. In exemplary embodiments, as shown in FIGS. 19-20, a flat panel mounting structure 1015 has two wind turbines 1022, one mounted on each of the first and second edge 1024, 1026. Each turbine 1022a, 1022b may include a vertical shaft 1038 to allow the turbine blades 1029 to rotate upon contact with wind, and each turbine is mounted to the panel 1015 according to known VAWT mounting procedures.

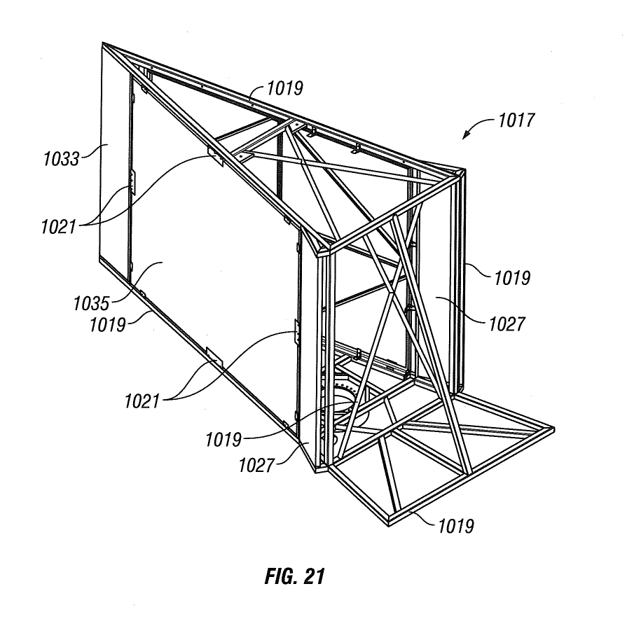

Referring to FIGS. 21-23, the mounting structure 1012 may comprise a frame assembly 1017 composed of various frame elements 1019. Outer plates are fixedly attached to the frame assembly 1017, e.g., by welding, or by brackets 1021 and may include transition plates 1027, a top front plate 1039, a top back plate 1031, tip plates 1033, and side plates 1035. Mounting plates 1023 may also be provided and fixedly attached, for example by welding, to some of the frame elements 1019. The mounting plates 1023 provide a substantially flat location for mounting the wind turbines 1022 to the mounting structure 1012. In exemplary embodiments, there are two mounting plates 1023a and 1023b, each positioned flush with a rear corner of the frame assembly 1017 of the mounting structure 1012. Each wind turbine 1022a, 1022b may be mounted on a respective mounting plate 1023a, 1023b via a respective pole mount 1025a, 1025b. A trap door 1003 may be provided in the floor 1005 of the mounting structure to allow easy access to the internal space.

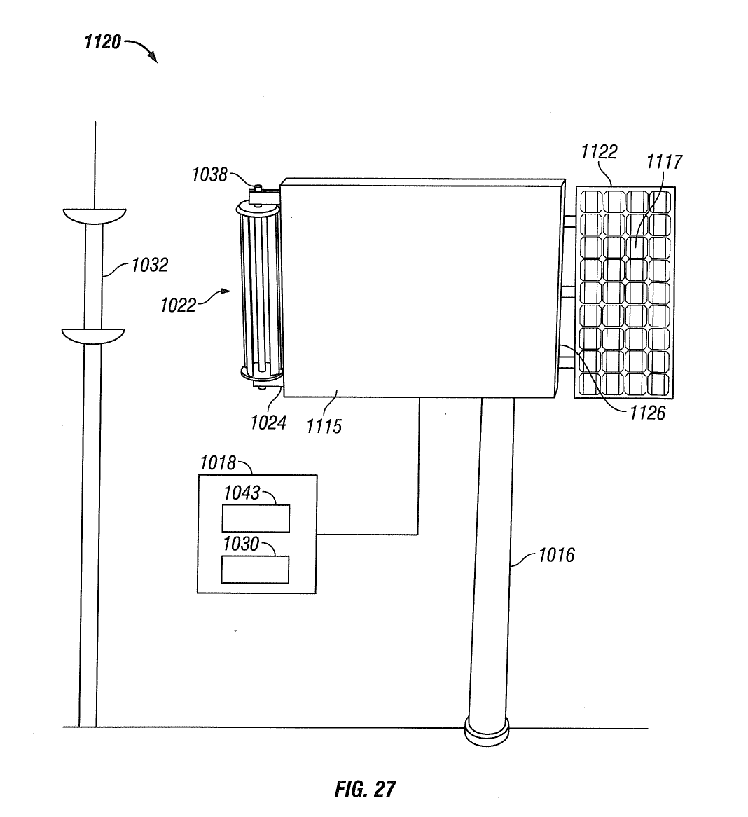

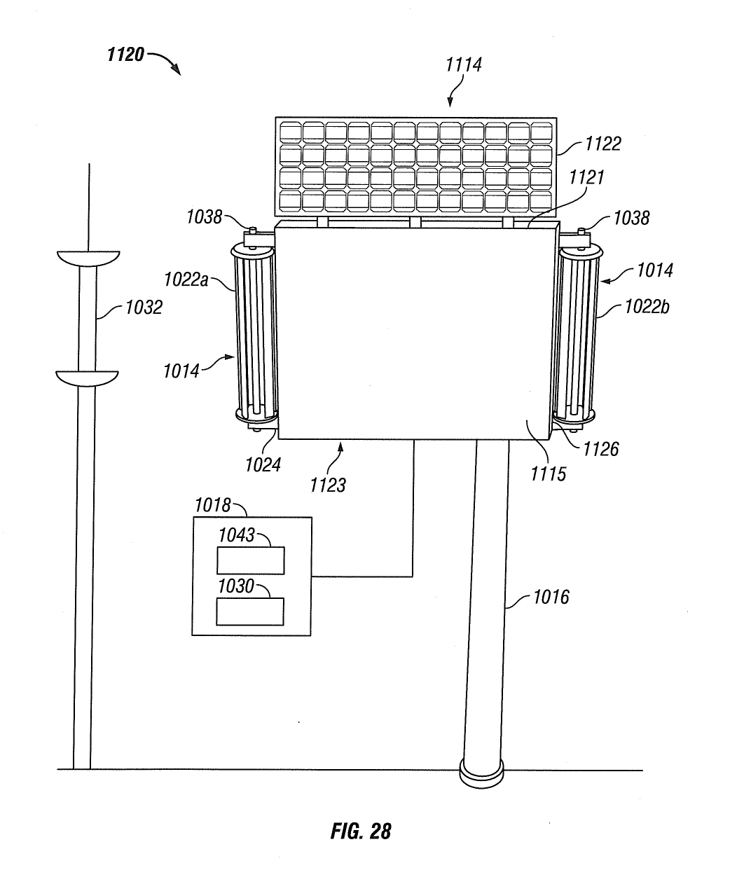

As shown schematically in FIGS. 27 and 28, an orienting assembly 1018 is operatively connected to the mounting structure 1012, including by appropriate mechanical linkages and/or electrical connections to orient the mounting structure 1012 such that the energy conversion devices 1014 are in optimal position to receive and convert renewable energy resources such as wind or sunlight. In embodiments employing wind turbines 1022, the orienting assembly 1018 includes wind-specific orienting mechanism such as a yaw control mechanism 1043. However, unlike known wind energy systems in which the turbines orient in relation to the wind, it is the mounting structure itself that orients to optimize turbine position. Moreover, in exemplary embodiments, the entire mounting structure orients and changes its angle with respect to the wind to adjust the turbine position appropriately. This advantageously simplifies the wind turbine assembly by obviating the need to incorporate orienting components in the wind turbine assembly.

Exemplary orienting assemblies for wind energy systems may include a control system 1030. The control system 1030 may utilize a met, or meteorological, tower 1032, which collects wind data and assesses wind resources. The met tower may have anemometers, wind direction vanes, temperature and pressure sensors, and other measurement devices attached to it at various levels above the ground for collecting the wind data. Disclosed systems also may utilize a Doppler technology and/or laser readings that calculate the most optimal orientations for the wind energy system to capture air flow. Using the wind data from the met tower 1032, Doppler, and/or laser readings, the control system 1030 signals other systems in the orienting assembly 1018 to adjust the mounting structure 1012 accordingly.

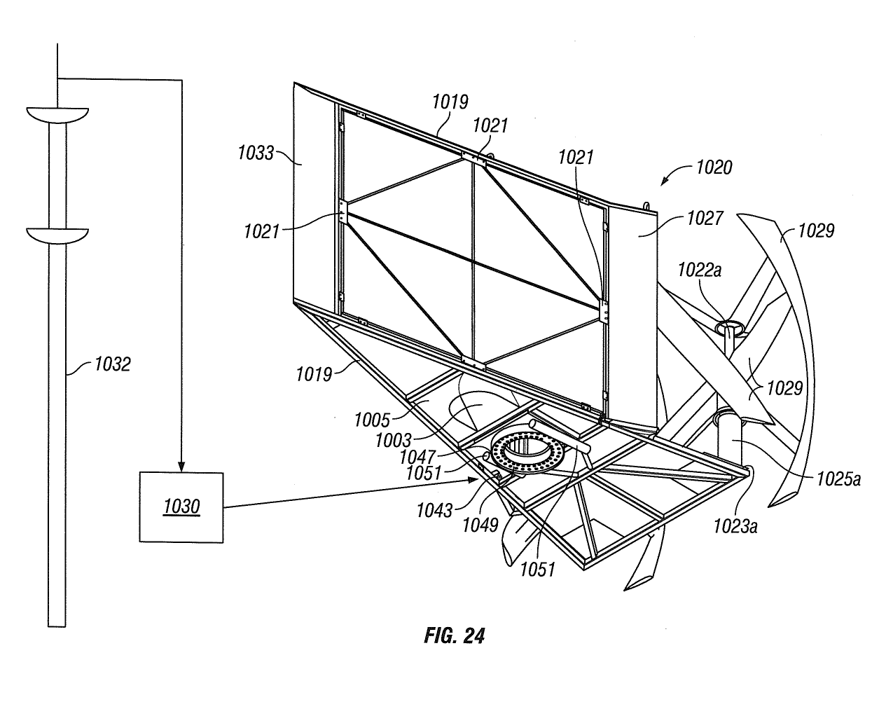

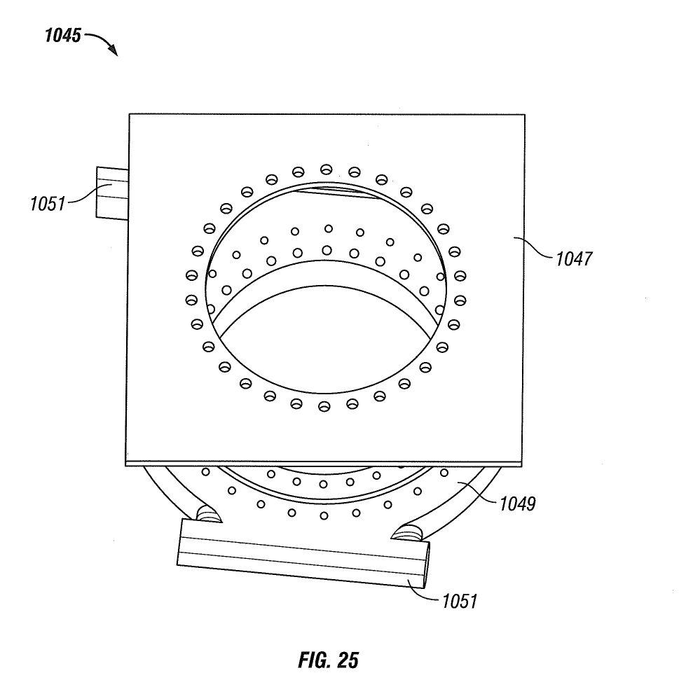

More particularly, the control system 1030 may effect yaw control adjustments and change the degree of the yaw of one or more of the wind turbines 1022a, 1022b. As best seen in FIGS. 24-25, an exemplary embodiment of a yaw control mechanism 1043 comprises a slew drive assembly 1045, including a ring bearing plate 1047 and a slew bearing plate 1049 with one or more flange and rod components 1051. It should be noted that any kind of yaw system could be used, including any type of active or passive yaw system. By reacting to data collected by the met tower 1032 and other measurement instruments, the control system 1030 signals the yaw control mechanism 1043 which direction and to what degree to turn the slew drive assembly 1045. It should be understood that such changes in yaw of the turbines may be effected through any known slew bearings and/or other servo geared or non-geared mechanisms in operative connection with the mounting structure 1012.

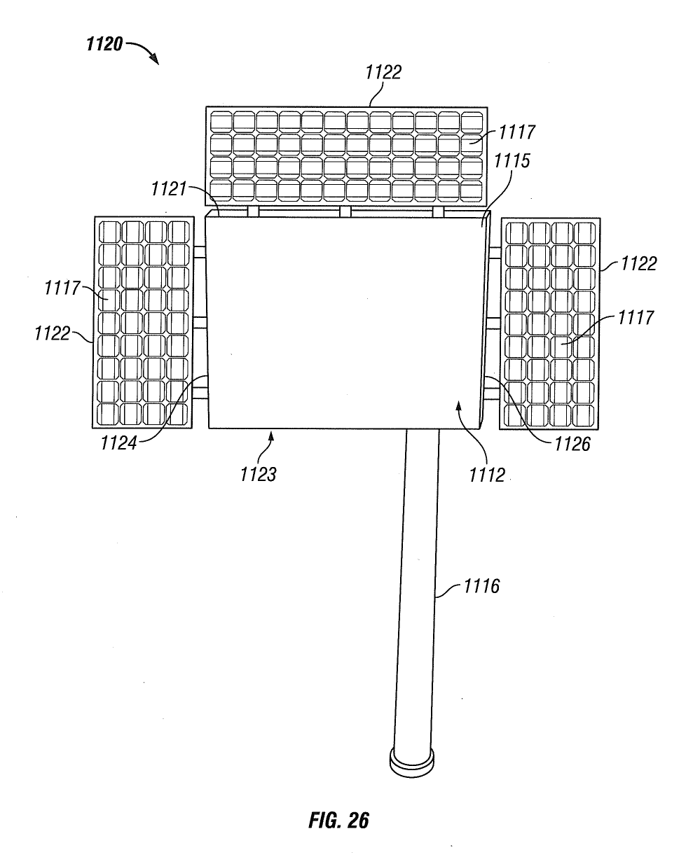

With reference to FIG. 26, exemplary embodiments of renewable energy systems may be solar energy systems 1120. An exemplary solar energy system 1120 includes a mounting structure 1112 having one or more solar panels 1122 mounted thereon. The solar panels 1122 are modules comprised of photovoltaic cells 1117, as is known in the art. The mounting structure 1112 could be any shape, and in exemplary embodiments is a flat panel mounting structure 1115 having a top edge 1121, a bottom edge 1123, a first side edge 1124, and a second side edge 1126. Solar panels 1122 may be mounted on one or more of the top edge 1121, bottom edge 1123, first side edge 1124, and second side edge 1126. Any type of solar panel mounting equipment may be used to mount the solar panels 1122 to the mounting structure 1115, such as fixed mount systems, tracking mount systems, rail mounts, pole mounts, and single arm mounts. Advantageously, the solar panels do not need solar trackers coupled thereto because the mounting structure itself will orient the solar panels. The yaw control mechanism 1043 described above, or other types of yaw control systems, can be used to orient the mounting structure 1112 so the solar panels 1122 face the sun and are optimized to receive the sunlight.

As seen in FIGS. 27-28, exemplary embodiments of renewable energy systems 1120 may be hybrid systems that include both solar energy conversion devices such as solar panels 1122 and wind energy conversion devices such as wind turbines 1022. Many different configurations are possible, including a wind turbine 1022 mounted on the first side edge 1124 of the flat panel mounting structure 1115 and a solar panel 1122 mounted on the second side edge 1126 of the flat panel mounting structure 1115. Another exemplary configuration would feature a first wind turbine 1022a on the first side edge 1124 of the flat panel mounting structure 1115, a second wind turbine 1022b mounted on the second side edge 1126 of the flat panel mounting structure 1115, and a solar panel 1122 on one or more of the top edge 1121 and bottom edge 1123 of the mounting structure 1115. It should be understood that such hybrid wind and solar energy systems would include both wind- and solar-specific orienting assemblies.

In operation, the met tower 1032 and/or a Doppler or laser system, collects the wind data and uses the data to calculate the most optimal orientations for the wind energy system to capture air flow. The control system 1030 signals other systems in the orienting assembly 1018 to adjust the mounting structure 1012 accordingly. The control system 1030 may signal the yaw control mechanism 1043 which direction and to what degree to turn the slew drive assembly 1045, which turns the mounting structure 1012 and with it the wind turbines 1022 accordingly.

### EXAMPLE

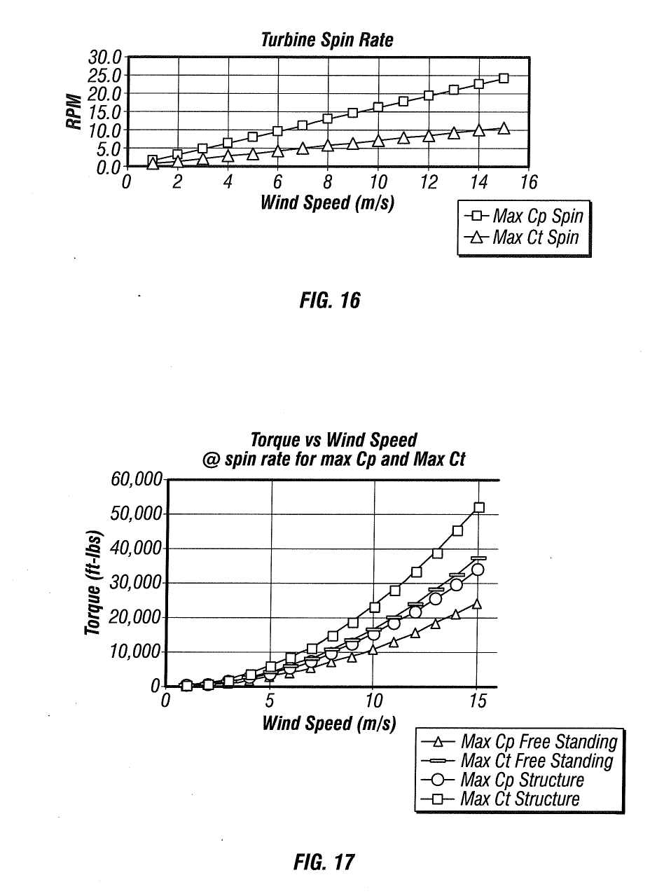

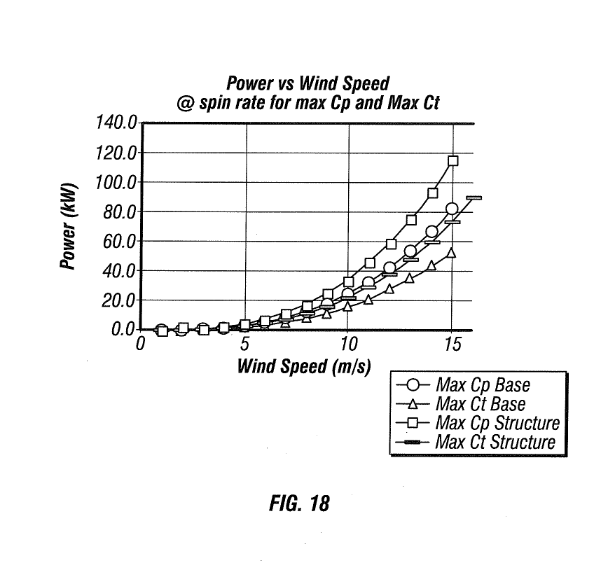

Disclosed wind energy systems and wind accelerators advantageously increase the air or wind speed by between about 10% and 50% as the air travels along the sides of the accelerator. Example 1 below shows the results of laboratory tests for turbine spin rate, torque vs wind speed and power vs wind speed data. The tests were performed in a computational fluid dynamics (CFD) laboratory. In particular, the tests used a CFD aerodynamics program called Fluent, which is known to provide more accurate results than wind tunnel testing. However, it should be noted that airflow is variable in a real world environment. The tests compared a computer-generated model of a disclosed prototype wind energy system embodiment having a wedge-shaped wind accelerator and Savonius turbines with a computer-generated model base system having a Savonius turbine mounted on a pole with no associated wind accelerator. TABLE 2A and FIG. 16 show the turbine spin rate as the wind speed increases. TABLE 3A and FIG. 17 show the improved torque using a wedge-shaped embodiment of a disclosed wind accelerator, and TABLE 4A and FIG. 18 show the improved power using a wedge-shaped embodiment of a disclosed wind accelerator.

### Example 1

### Data for Wedge-Shaped Accelerator

TABLE 1
Turbine Characteristics

Configuration

| buckets | 2 | |
|---|---|---|
| stages | 2 | |
| | (ft) | (m) |
| Rotor radius | 17.5 | 5.34 |
| Rotor Height | 48 | 14.63 |
| Swept Area | 1680 | 156.16 |
| Runaway Tip | | |
| Speed | X | 1.80 |

| | | Performance Coefficients | |
|---|---|---|---|
| | Symbol | base | structure |
| Max Cp Operation | | | |
| Tip speed ratio | X | 0.90 | 0.90 |
| Power Coefficient | Cp | 0.25 | 0.35 |
| Torque Coefficient | Ct | 0.28 | 0.39 |
| Max Ct Operation | | | |
| Tip speed ratio | X | 0.40 | 0.40 |
| Power Coefficient | Cp | 0.16 | 0.22 |
| Torque Coefficient | Ct | 0.43 | 0.60 |
| Other Inputs | | | |
| air density | | 1.25 | kg/m\hat{ }3 |

TABLE 2A
Turbine Spin Rate (Data)

| | Wind | | |
|---|---|---|---|
| Lab Data | Speed | Lab Data | Turbine |
| Torque lb. ft. | m/s | kWs | RPMs |
| 0 | 0.0 | 0.0 | |
| 134 | 1.0 | 0.00 | 1.70 |
| 536 | 2.0 | 0.20 | 3.40 |
| 1,205 | Cut In 3.0 | 0.60 | 5.10 |
| 2,143 | 4.0 | 1.30 | 6.80 |
| | 4.2 | | |
| | 4.4 | | |
| | 4.6 | | |
| | 4.8 | | |
| 3,348 | 5.0 | 4.00 | 8.50 |
| | 5.1 | | |
| | 5.4 | | |
| | 5.7 | | |
| 4,821 | 6.0 | 7.00 | 10.30 |
| | 6.3 | | |
| | 6.6 | | |
| | 6.9 | | |
| 6,562 | 7.0 | 11.00 | 12.00 |
| | 7.4 | | |
| | 7.8 | | |
| 8,571 | 8.0 | 16.50 | 13.70 |
| | 8.3 | | |
| | 8.7 | | |
| 10,847 | 9.0 | 23.50 | 15.40 |
| | 9.3 | | |
| | 9.7 | | |
| 13,392 | 10.0 | 32.30 | 17.10 |
| | 10.3 | | |
| | 10.7 | | |
| 16,204 | 11.0 | 42.90 | 18.80 |
| | 11.2 | | |
| | 11.5 | | |
| | 11.8 | | |
| 19,284 | 12.0 | 55.70 | 20.50 |
| | 12.2 | | |
| | 12.5 | | |
| | 12.8 | | |
| 22,632 | 13.0 | 70.80 | 22.20 |
| | 13.5 | | |
| 26,248 | 14.0 | 88.40 | 23.90 |
| | 14.5 | | |
| 30,132 | 15.0 | 108.70 | 25.60 |
| | 15.5 | | |
| 34,283 | 16.0 | 131.90 | 27.30 |
| | 16.5 | | |
| 38,702 | 17.0 | 158.20 | 29.00 |
| | 17.5 | | |
| 43,390 | 18.0 | 187.80 | 30.80 |
| | 18.5 | | |
| 48,345 | 19.0 | 220.90 | 32.50 |

TABLE 3A(i)
Torque Versus Wind Speed (Data)
TORQUE DATA (BASE 2 BUCKET, 2 STAGE SAVONIUS TURBINE)

| | | Max Torque Spin Rate | | | | | |
|---|---|---|---|---|---|---|---|
| Wind | Wind | spin | Tip | | Pow- | | |
| Speed | Speed | (rad/ | Speed | spin | er | Torque | Torque |
| (m/s) | (knots) | s) | ratio | (RPM) | (kW) | (n-m) | (ft-lbs) |
| 0 | | | | | | | |
| 1 | 1.9 | 0.1 | 0.4 | 0.7 | 0.0 | 224 | 165 |
| 2 | 3.9 | 0.1 | 0.4 | 1.4 | 0.1 | 896 | 661 |
| 3 | 5.8 | 0.2 | 0.4 | 2.1 | 0.4 | 2,015 | 1,487 |
| 4 | 7.8 | 0.3 | 0.4 | 2.9 | 1.0 | 3,583 | 2,644 |
| 5 | 9.7 | 0.4 | 0.4 | 3.6 | 2.0 | 5,598 | 4,131 |
| 6 | 11.7 | 0.4 | 0.4 | 4.3 | 3.4 | 8,061 | 5,949 |
| 7 | 13.6 | 0.5 | 0.4 | 5.0 | 5.4 | 10,972 | 8,097 |
| 8 | 15.6 | 0.6 | 0.4 | 5.7 | 8.0 | 14,330 | 10,576 |
| 9 | 17.5 | 0.7 | 0.4 | 6.4 | 11.4 | 18,137 | 13,385 |
| 10 | 19.5 | 0.7 | 0.4 | 7.2 | 15.6 | 22,391 | 16,525 |
| 11 | 21.4 | 0.8 | 0.4 | 7.9 | 20.8 | 27,093 | 19,995 |
| 12 | 23.3 | 0.9 | 0.4 | 8.6 | 27.0 | 32,243 | 23,795 |
| 13 | 25.3 | 1.0 | 0.4 | 9.3 | 34.3 | 37,841 | 27,927 |
| 14 | 27.2 | 1.0 | 0.4 | 10.0 | 42.8 | 43,886 | 32,388 |
| 15 | 29.2 | 1.1 | 0.4 | 10.7 | 52.7 | 50,380 | 37,180 |
| 16 | 31.1 | 1.2 | 0.4 | 11.5 | 64.0 | 57,321 | 42,303 |
| 17 | 33.1 | 1.3 | 0.4 | 12.2 | 76.7 | 64,710 | 47,756 |
| 18 | 35.0 | 1.3 | 0.4 | 12.9 | 91.1 | 72,547 | 53,540 |
| 19 | 37.0 | 1.4 | 0.4 | 13.6 | 107.1 | 80,832 | 59,654 |
| 20 | 38.9 | 1.5 | 0.4 | 14.3 | 124.9 | 89,564 | 66,098 |

TABLE 3A(ii)
Torque Versus Wind Speed (Data)
TORQUE DATA (OPTIMIZED SYSTEM WITH STRUCTURE
SINGLE 2 BUCKET, 2 STAGE SAVONIUS TURBINE)

| | | Max Torque Spin Rate | | | | | |
|---|---|---|---|---|---|---|---|
| Wind | Wind | spin | Tip | | Pow- | | |
| Speed | Speed | (rad/ | Speed | spin | er | Torque | Torque |
| (m/s) | (knots) | s) | ratio | (RPM) | (kW) | (n-m) | (ft-lbs) |
| 0 | | | | | | | |
| 1 | 1.9 | 0.1 | 0.4 | 0.7 | 0.0 | 313 | 231 |
| 2 | 3.9 | 0.1 | 0.4 | 1.4 | 0.2 | 1,254 | 925 |
| 3 | 5.8 | 0.2 | 0.4 | 2.1 | 0.6 | 2,821 | 2,082 |
| 4 | 7.8 | 0.3 | 0.4 | 2.9 | 1.4 | 5,016 | 3,702 |
| 5 | 9.7 | 0.4 | 0.4 | 3.6 | 2.7 | 7,837 | 5,784 |
| 6 | 11.7 | 0.4 | 0.4 | 4.3 | 4.7 | 11,285 | 8,328 |
| 7 | 13.6 | 0.5 | 0.4 | 5.0 | 7.5 | 15,360 | 11,336 |
| 8 | 15.6 | 0.6 | 0.4 | 5.7 | 11.2 | 20,062 | 14,806 |
| 9 | 17.5 | 0.7 | 0.4 | 6.4 | 15.9 | 25,391 | 18,739 |
| 10 | 19.5 | 0.7 | 0.4 | 7.2 | 21.9 | 31,347 | 23,134 |
| 11 | 21.4 | 0.8 | 0.4 | 7.9 | 29.1 | 37,930 | 27,993 |
| 12 | 23.3 | 0.9 | 0.4 | 8.6 | 37.8 | 45,140 | 33,314 |
| 13 | 25.3 | 1.0 | 0.4 | 9.3 | 48.0 | 52,977 | 39,097 |
| 14 | 27.2 | 1.0 | 0.4 | 10.0 | 60.0 | 61,441 | 45,343 |
| 15 | 29.2 | 1.1 | 0.4 | 10.7 | 73.8 | 70,532 | 52,052 |
| 16 | 31.1 | 1.2 | 0.4 | 11.5 | 89.5 | 80,249 | 59,224 |
| 17 | 33.1 | 1.3 | 0.4 | 12.2 | 107.4 | 90,594 | 66,858 |
| 18 | 35.0 | 1.3 | 0.4 | 12.9 | 127.5 | 101,566 | 74,956 |
| 19 | 37.0 | 1.4 | 0.4 | 13.6 | 150.0 | 113,164 | 83,515 |
| 20 | 38.9 | 1.5 | 0.4 | 14.3 | 174.9 | 125,390 | 92,538 |

TABLE 4A(i)
Power Versus Wind Speed (Data)
POWER DATA (BASE 2 BUCKET, 2 STAGE SAVONIUS TURBINE)

| | | Max Power Spin Rate | | | | | |
|---|---|---|---|---|---|---|---|
| Wind | Wind | spin | | Tip | Pow- | | |
| Speed | Speed | (rad/ | spin | Speed | er | Torque | Torque |
| (m/s) | (knots) | s) | (RPM) | ratio | (kW) | (n-m) | (ft-lbs) |
| 0 | | | | | | | |
| 1 | 1.9 | 0.2 | 1.6 | 0.9 | 0.0 | 146 | 108 |
| 2 | 3.9 | 0.3 | 3.2 | 0.9 | 0.2 | 583 | 430 |
| 3 | 5.8 | 0.5 | 4.8 | 0.9 | 0.7 | 1,312 | 968 |
| 4 | 7.8 | 0.7 | 6.4 | 0.9 | 1.6 | 2,333 | 1,722 |
| 5 | 9.7 | 0.8 | 8.1 | 0.9 | 3.0 | 3,645 | 2,690 |
| 6 | 11.7 | 1.0 | 9.7 | 0.9 | 5.3 | 5,249 | 3,874 |
| 7 | 13.6 | 1.2 | 11.3 | 0.9 | 8.4 | 7,144 | 5,272 |
| 8 | 15.6 | 1.3 | 12.9 | 0.9 | 12.5 | 9,331 | 6,887 |
| 9 | 17.5 | 1.5 | 14.5 | 0.9 | 17.8 | 11,810 | 8,716 |
| 10 | 19.5 | 1.7 | 16.1 | 0.9 | 24.4 | 14,580 | 10,760 |
| 11 | 21.4 | 1.9 | 17.7 | 0.9 | 32.5 | 17,642 | 13,020 |
| 12 | 23.3 | 2.0 | 19.3 | 0.9 | 42.2 | 20,996 | 15,495 |
| 13 | 25.3 | 2.2 | 20.9 | 0.9 | 53.6 | 24,641 | 18,185 |
| 14 | 27.2 | 2.4 | 22.6 | 0.9 | 67.0 | 28,577 | 21,090 |
| 15 | 29.2 | 2.5 | 24.2 | 0.9 | 82.3 | 32,805 | 24,210 |
| 16 | 31.1 | 2.7 | 25.8 | 0.9 | 99.9 | 37,325 | 27,546 |
| 17 | 33.1 | 2.9 | 27.4 | 0.9 | 119.9 | 42,137 | 31,097 |
| 18 | 35.0 | 3.0 | 29.0 | 0.9 | 142.3 | 47,240 | 34,863 |
| 19 | 37.0 | 3.2 | 30.6 | 0.9 | 167.4 | 52,635 | 38,844 |
| 20 | 38.9 | 3.4 | 32.2 | 0.9 | 195.2 | 58,321 | 43,041 |

TABLE 4A(ii)
Power Versus Wind Speed (Data)
POWER DATA (OPTIMIZED SYSTEM WITH STRUCTURE
SINGLE 2 BUCKET, 2 STAGE SAVONIUS TURBINE)

| | | Max Power Spin Rate | | | | | |
|---|---|---|---|---|---|---|---|
| Wind | Wind | spin | | Tip | Pow- | | |
| Speed | Speed | (rad/ | spin | Speed | er | Torque | Torque |
| (m/s) | (knots) | s) | (RPM) | ratio | (kW) | (n-m) | (ft-lbs) |
| 0 | | | | | | | |
| 1 | 1.9 | 0.2 | 1.6 | 0.9 | 0.0 | 204 | 151 |
| 2 | 3.9 | 0.3 | 3.2 | 0.9 | 0.3 | 816 | 603 |
| 3 | 5.8 | 0.5 | 4.8 | 0.9 | 0.9 | 1,837 | 1,356 |
| 4 | 7.8 | 0.7 | 6.4 | 0.9 | 2.2 | 3,266 | 2,410 |
| 5 | 9.7 | 0.8 | 8.1 | 0.9 | 4.3 | 5,103 | 3,766 |
| 6 | 11.7 | 1.0 | 9.7 | 0.9 | 7.4 | 7,348 | 5,423 |
| 7 | 13.6 | 1.2 | 11.3 | 0.9 | 11.7 | 10,002 | 7,381 |
| 8 | 15.6 | 1.3 | 12.9 | 0.9 | 17.5 | 13,064 | 9,641 |
| 9 | 17.5 | 1.5 | 14.5 | 0.9 | 24.9 | 16,534 | 12,202 |
| 10 | 19.5 | 1.7 | 16.1 | 0.9 | 34.2 | 20,412 | 15,064 |
| 11 | 21.4 | 1.9 | 17.7 | 0.9 | 45.5 | 24,699 | 18,228 |
| 12 | 23.3 | 2.0 | 19.3 | 0.9 | 59.0 | 29,394 | 21,693 |
| 13 | 25.3 | 2.2 | 20.9 | 0.9 | 75.0 | 34,497 | 25,459 |
| 14 | 27.2 | 2.4 | 22.6 | 0.9 | 93.7 | 40,008 | 29,526 |
| 15 | 29.2 | 2.5 | 24.2 | 0.9 | 115.3 | 45,928 | 33,895 |
| 16 | 31.1 | 2.7 | 25.8 | 0.9 | 139.9 | 52,255 | 38,565 |
| 17 | 33.1 | 2.9 | 27.4 | 0.9 | 167.8 | 58,992 | 43,536 |
| 18 | 35.0 | 3.0 | 29.0 | 0.9 | 199.2 | 66,136 | 48,808 |
| 19 | 37.0 | 3.2 | 30.6 | 0.9 | 234.3 | 73,688 | 54,382 |
| 20 | 38.9 | 3.4 | 32.2 | 0.9 | 273.3 | 81,649 | 60,257 |

Thus, it is seen that wind energy systems and methods are provided. It should be understood that any of the foregoing configurations and specialized components or chemical compounds may be interchangeably used with any of the systems of the preceding embodiments. Although illustrative embodiments of the present invention are described hereinabove, it will be evident to one skilled in the art that various changes and modifications may be made therein without departing from the invention. It is intended in the appended claims to cover all such changes and modifications that fall within the true spirit and scope of the invention.

What is claimed is:

1. A wind energy system comprising:
a mounting structure having a first edge, a second edge, a top edge and a bottom edge; and
one or more wind turbines mounted on the mounting structure;
the mounting structure orienting so the one or more wind turbines face into oncoming wind.

2. The system of claim 1 further comprising an orienting assembly in operable connection with the mounting structure.

3. The system of claim 2 wherein the orienting assembly comprises a yaw control mechanism.

4. The system of claim 2 wherein the orienting assembly comprises a control system.

5. The system of claim 4 further comprising a met tower in communication with the control system.

6. The system of claim 2 wherein the one or more wind turbines are mounted on one or more of the first edge and the second edge of the mounting structure.

7. The system of claim 1 wherein the one or more turbines is selected from the group: Darrieus vertical axis wind turbine and Savonius vertical axis wind turbine.

8. The system of claim 1 further comprising a rectifier and an inverter to provide electricity from the one or more wind turbines.

9. The system of claim 1 wherein the mounting structure is one of: substantially flat, curved, V-shaped, and W-shaped.

10. A renewable energy system comprising:
a mounting structure; and
one or more energy conversion devices mounted on the mounting structure;
the mounting structure orienting the one or more energy capturing devices to enhance their energy capturing capacity.

11. The renewable energy system of claim 10 wherein the one or more energy conversion devices includes a wind turbine.

12. The renewable energy system of claim 10 wherein the one or more energy conversion devices includes a solar panel.

13. The system of claim 10 further comprising an orienting assembly in operable connection with the mounting structure.

14. The system of claim 13 wherein the orienting assembly comprises a yaw control mechanism.

15. The system of claim 13 wherein the orienting assembly comprises a control system.

16. The system of claim 15 further comprising a met tower in communication with the control system.

17. The system of claim 9 wherein the mounting structure is one or more of: substantially flat curved, V-shaped, and W-shaped.

18. A method of orienting a wind energy system, comprising:
mounting one or more wind turbines on a substantially flat mounting structure having a first edge, a second edge, a top edge and a bottom edge; and
orienting the substantially flat mounting structure so the one or more wind turbines face into oncoming wind.

19. The method of claim 18 further comprising operably connecting an orienting assembly to the mounting structure, wherein the orienting step comprises using the orienting assembly to orient the mounting structure.

20. The method of claim 19 wherein the orienting assembly comprises one or more of: a yaw control mechanism, a control system, and a met tower.
